(19) United States
(12) Patent Application Publication
(10) Pub. No.: US 2019/0201933 A1
(43) Pub. Date: Jul. 4, 2019

(54) TRANSMITTING AND RECEIVING DEVICE AND ULTRASOUND SYSTEM

(71) Applicant: GENERAL ELECTRIC COMPANY, Schenectady, NY (US)

(72) Inventors: Jianlin Li, Shanghai (CN); Jing Li, Shanghai (CN); Weihua Shang, Shanghai (CN); Baoming Huang, Shanghai (CN); Heng Wu, Shanghai (CN)

(73) Assignee: Baker Hughes Oilfield Operations LLC, Houston, TX (US)

(21) Appl. No.: 16/327,538

(22) PCT Filed: Aug. 3, 2017
(86) PCT No.: PCT/US2017/045211

§ 371 Date: Feb. 22, 2019

(30) Foreign Application Priority Data
Aug. 30, 2016 (CN) 201610781968.1

(51) Int. Cl. B06B 1/02; G01S 7/52; G01S 7/524; G01S 7/526

(52) U.S. Cl. CPC B06B 1/0215; G01S 7/5202; G01S 7/526; G01S 7/52025; G01S 7/524

(57) ABSTRACT

The present invention discloses a transmitting and receiving device for an ultrasonic system, which comprises a transmitter, a receiver and at least two switch circuits connected in series. The transmitter is coupled to an ultrasonic transducer and generates high voltage signals to the ultrasonic transducer during a transmitting mode. The receiver is coupled to the ultrasonic transducer via the at least two switch circuits and receives low voltage signals from the ultrasonic transducer during a receiving mode. The at least two switch circuits are configured to share voltage drop of the high voltage signals to isolate the high voltage signals during the transmitting mode and allow the low voltage signals to pass through during the receiving mode. It also discloses an ultrasonic system having the transmitting and receiving device.

### FIELD

The present invention generally relates to the field of ultrasound, and more particularly to a transmitting and receiving device for an ultrasonic system and an ultrasonic system having the transmitting and receiving device.

### BACKGROUND

For the application of an ultrasonic transducer with a transmitter and a receiver integrated, a high-voltage transmitter and a low-noise receiver are generally connected together via a transmit/receive switch (T/R switch). The T/R switch is a high voltage current limiting protection device that protects the low noise receiver from the influence of high voltage pulse signals.

During operation, the high-voltage transmitter can send high-voltage pulse signals, such as ±100 volts, to the ultrasonic transducer. Meanwhile, the T/R switch can protect the low-noise receiver from the influence of the high voltage pulse signals. The transmitted high voltage pulse signals enable the ultrasonic transducer to vibrate, so as to generate sound wave. The sound wave hits an object, resulting in sound wave echo. The sound wave echo returns to the ultrasonic transducer. The ultrasonic transducer can convert the sound wave echo to electrical signals (which could generally be referred to as received signals) typically no more than a few hundred millivolts. The T/R switch can allow the small received signals to pass through and be received by the receiver. Signals from the receiver can be further processed for image reconstruction.

The T/R switch only allows small voltage signals to pass through. Once the voltage drop across the T/R switch exceeds its voltage threshold (for example, typically ±2 volts), the T/R switch will be disconnected so as to prevent the high voltage signals from passing through. However, the protection capability for the T/R switch is limited. The T/R switch will be damaged when the applied high voltage pulse signals cause the voltage drop across the T/R switch to exceed its maximum rated withstand voltage.

Accordingly, it is necessary to provide an improved solution for solving at least one of the technical problems as mentioned above.

### SUMMARY

One aspect of the present invention is to provide a transmitting and receiving device for an ultrasonic system. The transmitting and receiving device comprises a transmitter, a receiver and at least two switch circuits connected in series. The transmitter is coupled to an ultrasonic transducer and generates high voltage signals to the ultrasonic transducer during a transmitting mode. The receiver is coupled to the ultrasonic transducer via the at least two switch circuits and receives low voltage signals from the ultrasonic transducer during a receiving mode. The at least two switch circuits are configured to share voltage drop of the high voltage signals to isolate the high voltage signals during the transmitting mode and allow the low voltage signals to pass through during the receiving mode.

Another aspect of the present invention is to provide an ultrasonic system. The ultrasonic system comprises an ultrasonic transducer, a transmitting and receiving device and a controller. The transmitting and receiving device comprises a transmitter, a receiver and at least two switch circuits connected in series. The transmitter is coupled to an ultrasonic transducer and configured to generate high voltage signals to the ultrasonic transducer during a transmitting mode. The receiver is coupled to the ultrasonic transducer via the at least two switch circuits and configured to receive low voltage signals from the ultrasonic transducer during a receiving mode. The at least two switch circuits are configured to share voltage drop of the high voltage signals to isolate the high voltage signals during the transmitting mode and allow the low voltage signals to pass through during the receiving mode. The controller is used to control the transmitter and the receiver.

### BRIEF DESCRIPTION OF THE DRAWINGS

These and other features, aspects and advantages of the present invention can be understood better in light of the following detailed description with reference to the accompanying drawings, in which the same reference signs represent the same components in the whole drawings, in which:

FIG. 1 is a schematic diagram of an ultrasonic system according to an embodiment of the present invention; and

FIG. 2 is a schematic diagram of an ultrasonic system according to another embodiment of the present invention.

### DETAILED DESCRIPTION

In order to help the person skilled in the art to exactly understand the subject matters claimed by the present invention, detailed description for embodiments of the present invention will be given with reference to the accompanying drawings in the following. In the following detailed description for those embodiments, some known functions or structures will not be described in details by the Description, to avoid disclosure of the present invention to be affected by unnecessary details.

Unless defined otherwise, the technical or scientific terms used in the Claims and the Description should have meanings as commonly understood by one of ordinary skilled in the art to which the present disclosure belongs. The terms “first”, “second” and the like in the Description and the Claims do not mean any sequential order, quantity or importance, but are only used for distinguishing different components. The terms “a”, “an” and the like do not denote a limitation of quantity, but denote the existence of at least one. The terms “comprises”, “comprising”, “includes”, “including”, “haves”, “having” and the like mean that the element or object in front of the “comprises”, “comprising”, “includes”, “including”, “haves” and “having” covers the elements or objects and their equivalents illustrated following the “comprises”, “comprising”, “includes”, “including”, “haves” and “having” but do not exclude other elements or objects. The term “coupled” or “connected” or the like is not limited to being connected physically or mechanically, but may comprise electric connection, no matter directly or indirectly.

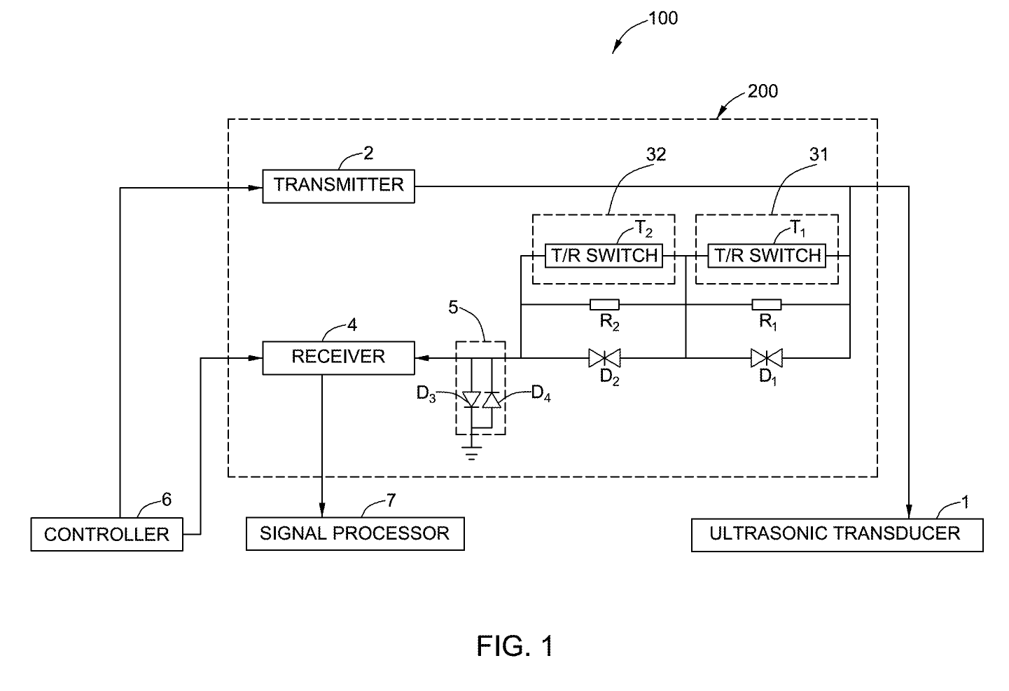

FIG. 1 illustrates a schematic diagram of a schematic transmitting and receiving device 200 for an ultrasonic system 100 according to an embodiment of the present invention. As shown in FIG. 1, the transmitting and receiving device 200 comprises a transmitter 2, a receiver 4 and at least two switch circuits 31, 32 connected in series. In FIG. 1, the transmitting and receiving device 200 is shown as including two switch circuits 31, 32 connected in series. The two switch circuits 31, 32 connected in series shown in FIG. 1 only serve as an example of explaining and illustrating the configuration of the transmitting and receiving device 200 of the present invention. However, the transmitting and receiving device 200 of the present invention is not limited to only two switch circuits 31, 32 connected in series. In fact, in the present invention, the transmitting and receiving device 200 may further comprise three or more switch circuits connected in series, that is the transmitting and receiving device 200 of the present invention may cover all embodiments of at least two switch circuits connected in series. The number of switch circuits connected in series included in the transmitting and receiving device 200 of the present invention may depend on required voltage withstand capability, that is voltage isolation capability required to provide. In the transmitting and receiving device 200 of the present invention, a higher voltage isolation capability can be provided for the receiver 4 by increasing the number of the switching circuits connected in series.

The transmitter 2 may be coupled to the ultrasonic transducer 1 and generate ultrasound pulse signals, i.e. high voltage signals, to the ultrasonic transducer 1 during a transmitting mode. Meanwhile, during the transmitting mode, the at least two switch circuits 31, 32 can share voltage drop of the high voltage signals transmitted by the transmitter 2 together, thereby to isolate the high voltage signals transmitted by the transmitter 2. Therefore, the high voltage signals transmitted by the transmitter 2 cannot pass through the switch circuits 31, 32 and get received by the receiver 4. Thus, by using at least two switch circuits 31, 32 connected in series, the switch circuits can withstand a higher voltage so that the transmitter 2 can transmit stronger ultrasound pulse signals.

The transmitted high voltage pulse signals arrive at the ultrasonic transducer 1 and enable the ultrasonic transducer 1 to vibrate so as to generate sound wave. The sound wave hits an object (not shown) to be detected, resulting in sound wave echo. The sound wave echo returns to the ultrasonic transducer 1. The ultrasonic transducer 1 can convert the sound wave echo to electrical signals, which are low voltage signals.

The receiver 4 may be coupled to the ultrasonic transducer 1 via the at least two switch circuits 31, 32 and receive low voltage signals from the ultrasonic transducer 1 during a receiving mode. During the receiving mode, the at least two switch circuits 31, 32 may allow the low voltage signals to pass through so as to be received by the receiver 4.

By using the at least two switch circuits 31, 32 connected in series, the voltage drop of the high voltage signals are divided to the at least two switch circuits 31, 32. Therefore, comparing to a typical single T/R switch, the at least two switch circuits 31, 32 connected in series of the present invention will be able to withstand a higher voltage drop, thereby providing a high voltage protection capability for the receiver 4.

As an example, the switch circuit may include a transmit/receive (T/R) switch. For example, the switch circuit 31 may include T/R switch T₁, and the switch circuit 32 may include T/R switch T₂. The two T/R switches T₁ and T₂ are substantially the same.

The T/R switches T₁ and T₂ may be used in the ultrasonic system 100, for protecting the low noise receiver 4 from the influence of high voltage pulse signals. The T/R switch T₁, T₂ are a normally off switch with a typical switch resistance of approximately 15Ω, capable of delivering weak signals. Once the voltage drop across the T/R switches T₁, T₂ exceeds their nominal voltage, the T/R switches T₁, T₂ are turned off so as to prevent strong signals, i. e. high voltage signals, from passing through.

Considering that when the at least two T/R switches T₁, T₂ are used in series, the voltage drop of the high voltage signal may not be equally divided to the at least two circuit T/R switches T₁, T₂ due to the difference between the devices themselves and/or circuits. Thus, in another embodiment of the present invention, the transmitting and receiving device 200 may further comprise at least two resistors R₁, R₂, each of the transmit/receive switches is connected in parallel with one resistor. For example, the T/R switch T₁ is connected in parallel with the resistor R₁, and the T/R switch T₂ is connected in parallel with the resistor R₂.

The resistors R₁, R₂ may balance the difference between the T/R switch T₁, T₂, and protect the T/R switch T₁, T₂. Therefore, the voltage drop of the high voltage signals may be divided equally to the T/R switch T₁, T₂ so that the damage caused by the voltage drop across the T/R switch exceeding its maximum rated voltage can be avoided. Therefore, the at least two T/R switch T₁, T₂ connected in series of the present invention can provide a high voltage protection capability.

Furthermore, considering that the response speed of the resistors R₁, R₂ is relatively slow, in another embodiment of the present invention, besides the at least two resistors R₁, R₂, the transmitting and receiving device 200 may further include at least two transient voltage suppression devices, and each transmit/receive switch is connected in parallel with one resistor and one transient voltage suppression device. The transient voltage suppression devices may for example include transient voltage suppression diodes D₁, D₂. For example, the T/R switch T₁ is connected in parallel with the resistor R₁ and the transient voltage suppression diode D₁ respectively, and the T/R switch T₂ is connected in parallel with the resistor R₂ and the transient voltage suppression diode D₂ respectively. In the transmitting and receiving device 200 as shown in FIG. 1, clamping voltages of the transient voltage suppression diodes D₁, D₂ are identical.

In another modified embodiment of the present invention, the transmitting and receiving device 200 may further merely include at least two transient voltage suppression devices without resistors. In this case, each transmit/receive switch is connected in parallel with one transient voltage suppression device. For example, the T/R switch T₁ is connected in parallel with the transient voltage suppression diode D₁, and the T/R switch T₂ is connected in parallel with the transient voltage suppression diode D₂.

The transient voltage suppression diodes D₁, D₂ are high efficiency circuit protection devices with extremely fast response times (sub-nanosecond) and very high surge absorptive capacity. When two ends of the transient voltage suppression diodes D₁, D₂ experience instantaneous high energy impact, the transient voltage suppression diodes D₁, D₂ can change the impedance value between the two ends from a high impedance to a low impedance at an extremely high rate to absorb instantaneous high current, so as to clamp the voltage across the two ends to a predetermined value, thereby protecting circuit elements from the impact of the transient high voltage spike pulses.

After the at least two switch circuits 31, 32 of the present invention are connected in parallel to the transient voltage suppression diodes D₁, D₂, the at least two switch circuits 31, 32 of the present invention can have shorter response time and better protection for the T/R switches T₁ and T₂. The at least two switch circuits 31, 32 connected in series of the present invention can provide the receiver 4 with higher and more efficient voltage protection capability. The transient voltage suppression diodes D₁, D₂ are chosen in a reasonable way, so that the protection voltage of the transient voltage suppression diodes D₁, D₂ does not exceed the maximum withstand voltage of the T/R switches T₁ and T₂. Therefore, the T/R switches T₁ and T₂ can be protected.

Continuing referring to FIG. 1, the transmitting and receiving device 200 of the present invention may further comprise a clamping circuit 5. The clamping circuit 5 may be coupled between the at least two switch circuits 31, 32 and the receiver 4. The clamping circuit 5 may include diodes D₃, D₄ connected in reverse parallel. An anode of the diode D₃ is electrically connected to a cathode of the diode D₄, an anode of the diode D₄ is electrically connected to a cathode of the diode D₃, and the anode of the diode D₃ is grounded. The diodes D₃ and D₄ may be, for example, Schottky diodes.

Referring to FIG. 1, under the transmitting mode, when high voltage pulse signals are applied by the transmitter 2, at the beginning the resistors R₁, R₂ divide the voltage drop of the high voltage pulse signals equally to the T/R switch T₁, T₂. Then, the high voltage signals continue to increase, when the voltage drop across the two ends of the first level T/R switch T₁ exceeds its voltage threshold, the T/R switch T₁ will turn off. Therefore, most of the voltage drop will only be loaded to the T/R switch T₁. As the high voltage signals continue to increase, the voltage drop across the two ends of the first level T/R switch T₁ reaches a breakdown voltage of the transient voltage suppression diode D₁. Therefore, avalanche breakdown happens in the transient voltage suppression diode D₁, that is the transient voltage suppression diode D₁ will turn on, and the remaining voltage of the high voltage signals will be loaded onto the second level T/R switch T₂, so that the T/R switches T₁ and T₂ are protected from over-voltage damage.

Under the receiving mode, when small ultrasonic backlash voltage signals are being received, since the voltage drop of the low voltage signals is lower than a voltage threshold of the T/R switches T₁ and T₂, the T/R switches T₁ and T₂ will be closed, that is in an ON state. In this case, the receiver 4 will be able to receive the low voltage signals.

The transmitting and receiving device 200 of the present invention can simplify the design of the ultrasonic system 100, and improve the reliability of the ultrasonic system 100. The transmitting and receiving device 200 of the present invention can provide higher and more efficient voltage protection capability for the receiver 4.

The present invention also provides an ultrasonic system 100. As shown in FIG. 1, the ultrasonic system 100 comprises an ultrasonic transducer 1, the transmitting and receiving device 200 as mentioned above, a controller 6 and a signal processor 7. The controller 6 may control the transmitter 2 and the receiver 4 in the transmitting and receiving device 200. The signal processor 7 may process the received low voltage signal from the receiver 4 so as to obtain an image of detected objected.

The ultrasonic system 100 of the present invention is simple in design and has high reliability.

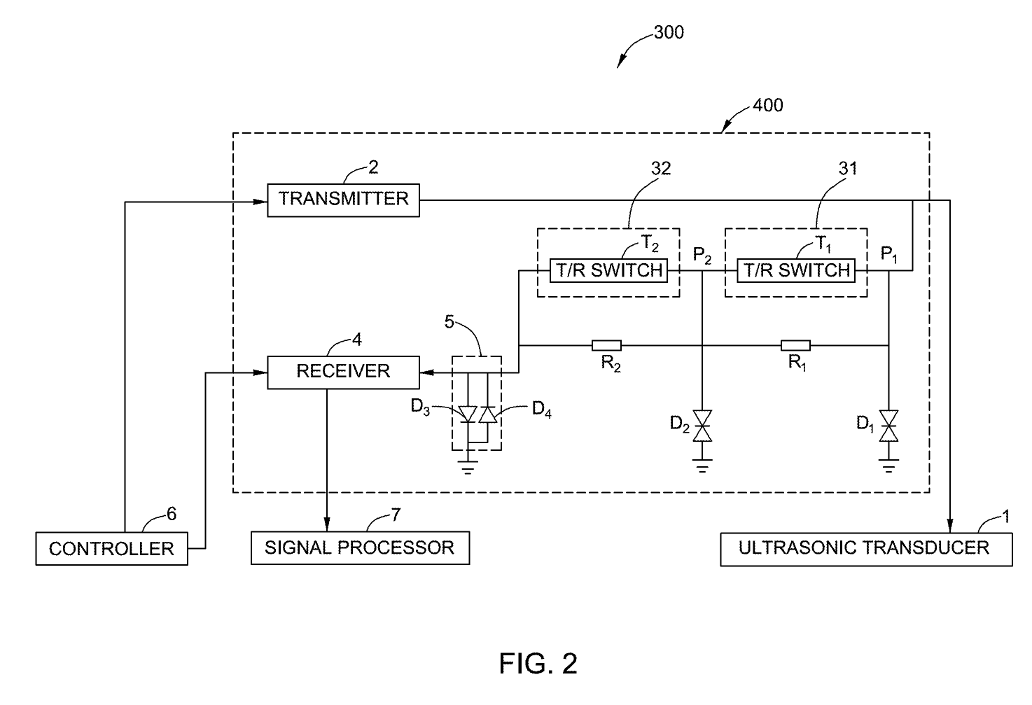

FIG. 2 shows a schematic diagram of an ultrasonic system 300 according to another embodiment of the present invention. As shown in FIG. 2, the ultrasonic system 300 may include a transmitting and receiving device 400 of another embodiment. Similar to the transmitting and receiving device 200 shown in FIG. 1, the transmitting and receiving device 400 as shown in FIG. 2 also comprises a transmitter 2, a receiver 4 and at least two switch circuits 31, 32 connected in series. In FIG. 2, as an embodiment, the switch circuits connected in series are shown to include two switch circuits 31, 32 connected in series, but the switch circuits connected in series are not limited thereto, and may include three or more switch circuits connected in series. The switch circuit may include a transmit/receive (T/R) switch. For example, the switch circuit 31 may include the T/R switch T₁, and the switch circuits 32 may include the T/R switch T₂. The transmitting and receiving device 400 as shown in FIG. 2 may further comprise at least two resistors R₁, R₂, and each transmit/receive switch is connected in parallel with one resistor. For example, the T/R switch T₁ is connected in parallel with the resistor R₁, and the T/R switch T₂ is connected in parallel with the resistor R₂. The transmitting and receiving device 400 as shown in FIG. 2 may further comprise at least two transient voltage suppression devices D₁, D₂, and the transient voltage suppression devices can comprise for example transient voltage suppression diodes.

However, unlike the transmitting and receiving device 200 shown in FIG. 1, in the transmitting and receiving device 400 as shown in FIG. 2, a high voltage terminal of each transmit/receive switch is connected to an end of one transient voltage suppression diode, while the other end of the transient voltage suppression diode is grounded. For example, the high voltage terminal P₁ of the T/R switch T₁ is connected to an end of the transient voltage suppression diode D₁, and the other end of the transient voltage suppression diode D₁ is grounded; the high voltage terminal P₂ of the T/R switch T₂ is connected to an end of the transient voltage suppression diode D₂, and the other end of the transient voltage suppression diode D₂ is grounded. In addition, in the transmitting and receiving device 400 shown in FIG. 2, the clamping voltages of the at least two transient voltage suppression diodes D₁, D₂ are different, so that the T/R switches T₁, T₂ can be protected. For example, for the transmitting and receiving device 400 as shown in FIG. 2, the clamping voltage of the transient voltage suppression diode D₁ is greater than the clamping voltage of the transient voltage suppression diode D₂.

As another modified embodiment of the present invention, in the at least two T/R switches T₁, T₂ of the transmitting and receiving device 400, the transient voltage suppression device connected to the T/R switch at the highest voltage terminal may be omitted. For example, in the transmitting and receiving device 400 shown in FIG. 2, the transient voltage suppression diodes D₁ connected to the T/R switch T₁ at the highest voltage terminal P₁ may be omitted.

In the transmitting and receiving device 400 as shown in FIG. 2, a higher voltage isolation capability can be provided for the receiver 4 by increasing the number of the switching circuits connected in series as well.

Although the present invention has been set forth in details in combination with specific embodiments, the person skilled in the art shall be understood that many modifications and variations may be made to the present invention. Therefore, it should be recognized that the intention of the claims is to cover all these modifications and variations within the real concept and range of the present invention.

What is claimed is:

1. A transmitting and receiving device (200, 400) for an ultrasonic system comprising:
a transmitter (2) coupled to an ultrasonic transducer and generating high voltage signals to the ultrasonic transducer during a transmitting mode;
at least two switch circuits (31, 32) connected in series; and
a receiver (4) coupled to the ultrasonic transducer via the at least two switch circuits and receiving low voltage signals from the ultrasonic transducer during a receiving mode,
wherein the at least two switch circuits (31, 32) are configured to share voltage drop of the high voltage signals to isolate the high voltage signals during the transmitting mode and allow the low voltage signals to pass through during the receiving mode.

2. The transmitting and receiving device (200, 400) of claim 1, further comprising:
a clamping circuit (5) coupled between the at least two switch circuits and the receiver (4).

3. The transmitting and receiving device (200, 400) of claim 1, wherein the switch circuits (31, 32) comprise transmit/receive switches (T₁, T₂).

4. The transmitting and receiving device (200, 400) of claim 3, wherein the at least two transmit/receive switches (T₁, T₂) are substantially the same.

5. The transmitting and receiving device (200, 400) of claim 3, further comprising:
at least two resistors (R₁, R₂), each transmit/receive switch (T₁, T₂) being connected in parallel with one resistor.

6. The transmitting and receiving device (200, 400) of claim 3, further comprising:
at least two transient voltage suppression devices (D₁, D₂), each transmit/receive switch (T₁, T₂) being connected in parallel with one transient voltage suppression device.

7. The transmitting and receiving device (200) of claim 6, wherein clamping voltages of the at least two transient voltage suppression devices (D₁, D₂) are the same.

8. The transmitting and receiving device (200, 400) of claim 6, wherein the transient voltage suppression device comprises a transient voltage suppression diode.

9. The transmitting and receiving device (400) of claim 3, further comprising:
at least two transient voltage suppression devices (D₁, D₂), a high voltage terminal of each transmit/receive switch (T₁, T₂) being connected with a terminal of one transient voltage suppression device and the other terminal of the transient voltage suppression device being grounded.

10. The transmitting and receiving device (400) of claim 9, wherein clamping voltages of the at least two transient voltage suppression devices (D₁, D₂) are different.

11. An ultrasonic system (100, 300) comprising:
an ultrasonic transducer (1);
a transmitting and receiving device (200, 400) comprising:
a transmitter (2) coupled to an ultrasonic transducer and configured to generate high voltage signals to the ultrasonic transducer during a transmitting mode;
at least two switch circuits (31, 32) connected in series; and
a receiver (4) coupled to the ultrasonic transducer via the at least two switch circuits and configured to receive low voltage signals from the ultrasonic transducer during a receiving mode,
wherein the at least two switch circuits (31, 32) are configured to share voltage drop of the high voltage signals to isolate the high voltage signals during the transmitting mode and allow the low voltage signals to pass through during the receiving mode; and
a controller (6) for controlling the transmitter (2) and the receiver (4).

12. The ultrasonic system (100, 300) of claim 11, further comprising:
a signal processor (7) for processing the received low voltage signals.

13. The ultrasonic system (100, 300) of claim 11, wherein the transmitting and receiving device (200, 400) further comprises:
a clamping circuit (5) coupled between the at least two switch circuits (31, 32) and the receiver (4).

14. The ultrasonic system (100, 300) of claim 11, wherein the switch circuit (31, 32) comprises a transmit/receive switch (T₁, T₂).

15. The ultrasonic system (100, 300) of claim 14, further comprising:
at least two resistors (R₁, R₂), each transmit/receive switch (T₁, T₂) being connected in parallel with one resistor.

16. The ultrasonic system (100) of claim 14, further comprising:
at least two transient voltage suppression devices (D₁, D₂), each transmit/receive switch (T₁, T₂) being connected in parallel with one transient voltage suppression device.

17. The ultrasonic system (300) of claim 14, further comprising:
at least two transient voltage suppression devices (D₁, D₂), a high voltage terminal of each transmit/receive switch (T₁, T₂) being connected with a terminal of one transient voltage suppression device and the other terminal of the transient voltage suppression device being grounded.
